(19) United States
(12) Patent Application Publication
(10) Pub. No.: US 2009/0082168 A1
(43) Pub. Date: Mar. 26, 2009

(54) SPEED CHANGE GEAR MECHANISM FOR HAND-DRIVEN POWER GENERATOR

(76) Inventor: Jen-Yen Yen, Yenpu Hsiang (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/902,533

(22) Filed: Sep. 24, 2007

(51) Int. Cl. F16H 57/08; F16H 37/06

(52) U.S. Cl. 475/337; 475/330

(57) ABSTRACT

A cylindrical, high speed change ratio type peed change gear mechanism is disclosed to include a driving wheel rotatable by a crank handle, a first rotating wheel coupled to the driving wheel for synchronous rotation at the same speed and having pivoted small gears spaced around the border and meshed within a first gear ring, a second rotating wheel coupled to the small gears of the first rotating wheel for rotation with the small gears of the first rotating wheel and having pivoted small gears spaced around the border and meshed within a second gear ring, a third rotating wheel coupled to the small gears of the second rotating wheel for rotation with the small gears of the second rotating wheel and having pivoted small gears spaced around the border and meshed with a pinion of a power generating device, and a fixed third gear ring meshed with the small gears of the third rotating wheel.

### BACKGROUND OF THE INVENTION

1. Field of the Invention

The present invention relates to a hand-driven power generator and more particularly, to a speed change gear mechanism for hand-driven power generator.

2. Description of the Related Art

A hand-driven power generator has a crank handle for rotation by the user to drive the power generating unit. Because the crank handle is rotated by hand, the speed is limited. Therefore, a speed change gear mechanism is used and coupled between the crank handle and the power generating unit to accelerate the speed. A speed change gear mechanism for a conventional hand-driven power generator is a horizontally extending linking structure, i.e., using a number of gears of different diameters and having the gears meshed with one another at a same elevation. This design of speed change gear mechanism is functional, however it requires much installation space. However, due to the limitation of low speed change ratio, the speed of this design of speed change gear mechanism is limited.

### SUMMARY OF THE INVENTION

The present invention has been accomplished under the circumstances in view. It is therefore the main object of the present invention to provide a speed change gear mechanism for hand-driven power generator, which has a cylindrical configuration that requires less installation space and, which achieves a multistage speed change effect. To achieve this and other objects of the present invention, the speed change gear mechanism is mounted inside the housing of a hand-drive power generator and coupled between a crank handle and a pinion of a power generating unit for driving the power generating unit to generate electricity upon rotation of the crank handle, comprising a driving wheel coupled to the crank handle and provided with a driving gear, a first rotating wheel coupled to and rotatable by the driving gear and having equiangularly spaced small gears pivotally mounted thereon, a fixed first gear ring meshed with the small gears of the first rotating wheel, a second rotating wheel, which has a driven gear coupled to and rotatable by the small gears of the first rotating wheel and small gears pivotally mounted thereof and spaced around the driven wheel, a fixed second gear ring meshed with the small gears of the second rotating wheel, a third rotating wheel, which has a driven gear coupled to and rotatable by the small gears of the second rotating wheel and small gears pivotally mounted thereof and spaced around the driven wheel and meshed with the pinion of the power generating unit, and a fixed third gear ring meshed with the small gears of the third rotating wheel.

### BRIEF DESCRIPTION OF THE DRAWINGS

FIG. 1 is an exploded view of a hand-driven power generator embodying the present invention.

FIG. 2 is a sectional assembly view of the hand-driven power generator according to the present invention.

FIG. 3A is a sectional view taken along line A-A of FIG. 2.

FIG. 3B is a sectional view taken along line B-B of FIG. 2.

FIG. 3C is a sectional view taken along line C-C of FIG. 2.

### DETAILED DESCRIPTION OF THE PREFERRED EMBODIMENT

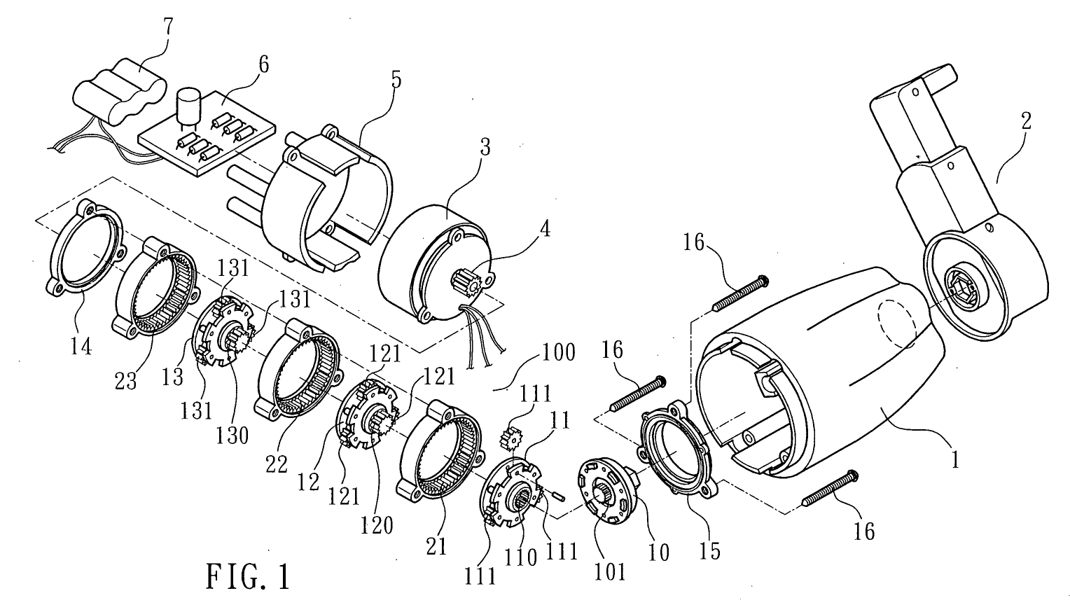

Referring to FIGS. 1, 2, 3A, 3B and 3C, a hand-driven power generator is shown comprising a housing 1, a power generating unit 3 mounted inside the housing 1 and having a pinion 4 at its input side, a crank handle 2 pivoted to the housing 1 on the outside, a speed change gear mechanism 100 mounted inside the housing 1 and coupled between the pinion 4 of the power generating unit 3 and the crank handle 2, a power rectifier circuit board 6 mounted outside the housing 1 and electrically connected to the power generator unit 3, and a storage battery 7 mounted outside the housing 1 and electrically connected to the power rectifier circuit board 6.

The speed change gear mechanism 100 comprises a driving wheel 10, a first rotating wheel 11, a first gear ring 21, a second rotating wheel 12, a second gear ring 22, a third rotating wheel 13, a third gear ring 23, two mounting rings 14 and 15, and a plurality of mounting screws 16 that fasten the mounting rings 14 and 15 and the gear rings 21-23 of the speed change gear mechanism 100 to the inside of the housing 1.

The driving wheel 10 has one side coupled to the crank handle 2 for rotation with the crank handle 2, and the other side fixedly provided with a driving gear 101. The first rotating wheel 11 comprises an internal gear 110 disposed at the center and meshed with the driving gear 101 for allowing rotation of the first rotating wheel 11 with the driving wheel 10, and a plurality of small gears 111 pivotally mounted therein and equiangularly spaced around the internal gear 110. The first gear ring 21 is mounted around the first rotating wheel 11 and meshed with the small gears 111. Therefore, the small gears 111 are rotated during rotation of the first rotating wheel 11. Because the first gear ring 21 has a relatively greater diameter and a relatively greater number of teeth than the small gears 111, the small gears 111 are rotated at a relatively higher speed than the first rotating wheel 11. The second rotating wheel 12 comprises a driven gear 120 fixedly provided at the front side and inserted into the first rotating wheel 11 and meshed with the small gears 111 of the first rotating wheel 11 for allowing the second rotating wheel 12 to be rotated by the small gears 111 of the first rotating wheel 11, and a plurality of small gears 121 pivotally mounted therein and equiangularly spaced around the driven gear 120. The second gear ring 22 is mounted around the second rotating wheel 12 and meshed with the small gears 121. Therefore, the small gears 121 are rotated during rotation of the second rotating wheel 12, and the rotating speed of the small gears 121 of the second rotating wheel 12 is faster than the driven gear 120 of the second rotating wheel 12. The third rotating wheel 13 comprises a driven gear 130 fixedly provided at the front side and inserted into the second rotating wheel 12 and meshed with the small gears 121 of the second rotating wheel 12 for allowing the third rotating wheel 13 to be rotated by the small gears 121 of the second rotating wheel 12, and a plurality of small gears 131 pivotally mounted therein and equiangularly spaced around the driven gear 130. The third gear ring 23 is mounted around the third rotating wheel 13 and meshed with the small gears 131 of the third rotating wheel 13. Therefore, the small gears 131 of the third rotating wheel 13 are rotated during rotation of the third rotating wheel 13, and the rotating speed of the small gears 131 of the third rotating wheel 13 is faster than the driven gear 130 of the third rotating wheel 13. Further, the pinion 4 of the power generating unit 3 is inserted into the third rotating wheel 13 and meshed with the small gears 131 of the third rotating wheel 13 for rotating by the small gears 131 of the third rotating wheel 13.

The crank handle 2 can be made folding collapsible to reduce the size when not in use. After installation of the power generating unit 3 and the speed change gear mechanism 100, a cap 5 is capped on the housing 1 to support the power rectifier circuit board 6 and the storage battery 7 on the outside of the housing 1.

According to the present invention, the first gear ring 21 is mounted around the first rotating wheel 11, the second gear ring 22 is mounted around the second rotating wheel 12, and the third gear ring 23 is mounted around the third rotating wheel 13, thereby constituting an assembly of “cylindrical configuration”. The driving wheel 10 is closely attached to the first rotating wheel 11 to force its driving gear 101 into engagement with the internal gear 110 of the first rotating wheel 11. The second rotating wheel 12 is closely attached to the first rotating wheel 11 to force its driven gear 120 into engagement with the small gears 111 of the first rotating wheel 11. The third rotating wheel 13 is closely attached to the second rotating wheel 12 to force its driven gear 130 into engagement with the small gears 121 of the second rotating wheel 12, constituting an assembly of “multi-stack series connection”. By means of the aforesaid “cylindrical configuration” and “multi-stack series connection”, a cylindrical speed change mechanism capable of providing a multi-stage speed change effect is thus obtained.

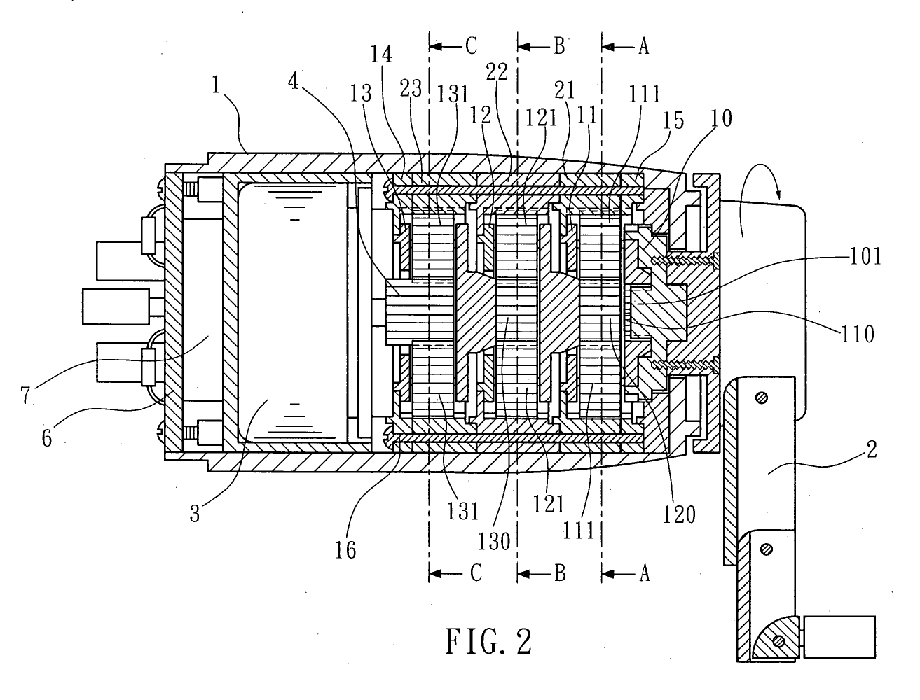

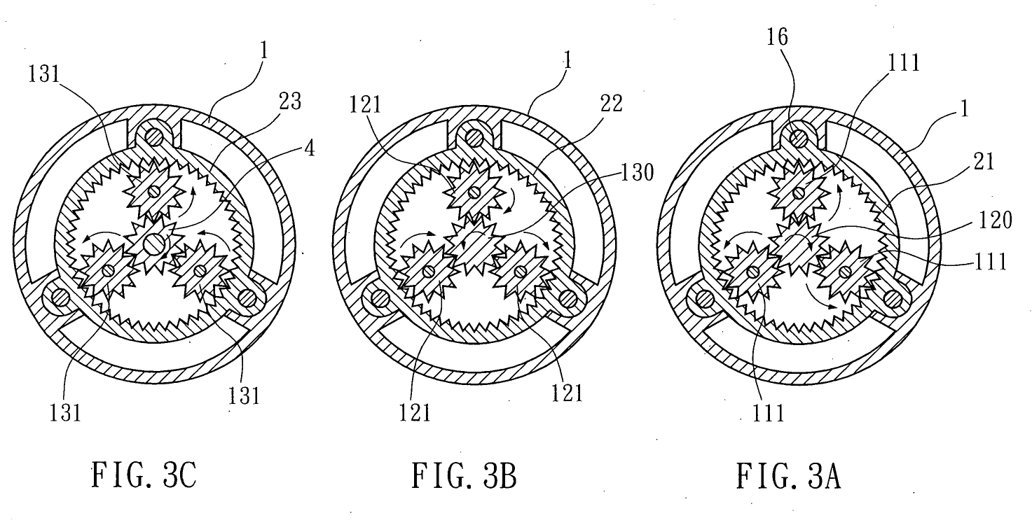

Referring to FIGS. 2, 3A, 3B and 3C again, when operating the crank handle 2 to rotate the driving wheel 10 of the speed change gear mechanism 100, causing the driving gear 101 to rotate the internal gear 110 of the first rotating wheel 11. Because the first gear ring 21 is affixed to the housing 1, the small gears 111 of the first rotating wheel 11 are forced to rotate the driven gear 120 of the second rotating wheel 12, and therefore the second rotating wheel 12 is rotated. Because the second gear ring 22 is affixed to the housing 1, the small gears 121 of the second rotating wheel 12 are forced rotate the driven gear 130 of the third rotating wheel 13 at this time, and therefore the third rotating wheel 13 is rotated. Because the third gear ring 23 is affixed to the housing 1, the small gears 131 of the third rotating wheel 13 are forced to rotate the pinion 4 of the power generating unit 3 during rotation of the third rotating wheel 13. Therefore the power generating unit 3 is driven to generate electricity during movement of the speed change gear mechanism, and the generated electricity is processed by the power rectifier circuit board 6 into DC power and stored in the storage battery 7.

The speed change gear mechanism 100 of the invention provides a multi-stage speed change effect. As shown in FIGS. 3A, 3B and 3C, the gear ratio between the small gears 111, 121, 131 of the first, second and third rotating wheels 11, 12, 13 and the first, second and third gear rings 21, 22, 23 are 1:4 (12 teeth:48 teeth). When the crank handle 2 is rotated through one turn, the first rotating wheel 11 is also rotated through one turn, and at the same time the small gears 111 of the first rotating wheel 11 are rotated through 4 turns (see FIG. 3A), and therefore the driven gear 120 of the second rotating wheel 12 is rotated through 4 turns. Further, because the number of teeth of the second rotating wheel 12 is four times of the number of teeth of the driven gear 120, the small gears 121 of the second rotating wheel 12 are rotated through 4×4=16 turns (see FIG. 3B). Further, because the number of teeth of the third rotating wheel 13 is four times of the number of teeth of the driven gear 130, the small gears 131 of the third rotating wheel 13 are rotated through 16×4=64 turns (see FIG. 3C). Therefore, when the crank handle 2 is rotated through one turn, the power generating unit 3 is rotated through 64 turns. Therefore, the invention obtains a first stage speed change (the small gears 111 of the first rotating wheel 11), the first stage speed change causes a second stage speed change (the small gears 121 of the second rotating wheel 12), and the second stage speed change causes a third stage speed change (the small gears 131 of the third rotating wheel 13). This multi-stage speed change effect accelerates the operation of the power generating unit 3.

Although a particular embodiment of the invention has been described in detail for purposes of illustration, various modifications and enhancements may be made without departing from the spirit and scope of the invention. For example, the speed change gear mechanism 100 can be composed of the first and second rotating wheels 11 and 12 with the first and second gear rings 21 and 22 without the aforesaid third rotating wheel 13 and third gear ring 23. The speed change gear mechanism 100 can also be made having an additional fourth rotating wheel and a fourth gear ring. Accordingly, the invention is not to be limited except as by the appended claims.

What the invention claimed is:

1. A speed change gear mechanism mounted inside a housing of a hand-drive power generator and coupled between a crank handle outside said housing and a pinion of a power generating unit inside said housing for driving said power generating unit to generate electricity upon rotation of said crank handle, the speed change gear mechanism comprising:
a driving wheel coupled to said crank handle for rotation with said crank handle, said driving wheel comprising a driving gear fixedly disposed at one side thereof opposite to said crank handle;
a first rotating wheel, said first rotating wheel comprising an internal gear disposed at the center thereof and meshed with said driving gear for allowing rotation of said first rotating wheel with said driving wheel, and a plurality of small gears pivotally mounted therein and equiangularly spaced around said internal gear;
a first gear ring fixedly mounted inside said housing around said first rotating wheel and meshed with the small gears of said first rotating wheel;
a second rotating wheel, said second rotating wheel comprising a driven gear fixedly provided at a front side thereof and inserted into said first rotating wheel and meshed with the small gears of said first rotating wheel for allowing said second rotating wheel to be rotated by the small gears of said first rotating wheel during rotation of said first rotating wheel, and a plurality of small gears pivotally mounted therein and equiangularly spaced around the driven gear of said second rotating wheel;
a second gear ring fixedly mounted inside said housing around said second rotating wheel and meshed with the small gears of said second rotating wheel;
a third rotating wheel, said third rotating wheel comprising a driven gear fixedly provided at a front side thereof and inserted into said second rotating wheel and meshed with the small gears of said second rotating wheel for allowing said third rotating wheel to be rotated by the small gears of said second rotating wheel during rotation of said second rotating wheel, and a plurality of small gears pivotally mounted therein and equiangularly spaced around the driven gear of said second rotating wheel and meshed with the pinion of said power generating unit; and
a third gear ring fixedly mounted inside said housing around said third rotating wheel and meshed with the small gears of said third rotating wheel.
